(19) United States
(12) Patent Application Publication
(10) Pub. No.: US 2004/0005100 A1
(43) Pub. Date: Jan. 8, 2004

(54) Flexible pouch with expandable polymer skeleton

(76) Inventor: Robert Thor Versluys, Florence, SC (US)

Correspondence Address: Thomas J. Durling, Drinker Biddle & Reath LLP, One Logan Square, 18th and Cherry Streets, Philadelphia, PA, 19103-6996, US

(21) Appl. No.: 10/188,418

(22) Filed: Jul. 3, 2002

(51) Int. Cl. B65D 33/02; B32B 1/02

(52) U.S. Cl. 383/119; 428/35.2; 428/36.5; 156/79; 156/291; 383/104; 383/116

(57) ABSTRACT

A dry food pouch is made from a laminate having a plurality of plies made from a flexible material and secured together by an adhesive. The laminate further includes at least one elongated strip of an expandable polymer material applied to a surface of one of the laminate plies. The pouch includes panels secured to each other to define a storage compartment. The pouch further includes reinforcing members that are formed by the elongated strips of expandable polymer material when they are activated to expand and harden.

### FIELD OF THE INVENTION

The present invention relates to containers, and more particularly to pouches made from laminates having film or foil plies for packaging of food products and the like.

### BACKGROUND OF THE INVENTION

Flexible pouches made from laminates containing plies of film or foil are used for packaging food products. There are a variety of pouch types that are used for packaging foods. Known pouch constructions include pouches having front and rear panels secured together along opposite sides to define a storage compartment. The pouches may also include gusseted bottom portions providing for self-support of the pouch when the pouch has been filled. Originally designed for liquids, these stand-up pouches are now also in wide use for packaging of solid food products, such as cereals and dry snacks, for example. Pouches may also include additional panels in addition to front and rear panels, such as a four-sided pouch defining a substantially rectangular storage compartment.

Although some pouch constructions are self-supporting, all pouches are inherently unstable, lacking in both lateral and vertical stiffness. As a result, the storage area defined by a pouch is easily deformed during handling of the pouch. When used to package liquids such as juice beverages, the lack of rigidity of a pouch is not a concern, as deformation does not affect the integrity of the beverage. However, when used to package a frangible food product, such as cookies for example, the inherent lack of rigidity of the pouch can present a problem for the integrity of the food product. A reinforced pouch construction for packaging frangible food items is, therefore, highly desirable.

It is known, as disclosed in U.S. Pat. No. 5,554,423 to Abate, to secure strand elements to a surface of a laminate sheet used to form a package. The package of Abate is a tubular bag for used for vacuum packaging of contents. The bag includes two laminate sheets heat sealed together such that the strand elements extend longitudinally along inner surfaces of the laminate sheets. The strands form longitudinally extending channels to facilitate removal of air from the bag by suction. Although, not intended for reinforcement of the sheets, the addition of the strands has the effect of increasing the section depth of the sheets. The change in the section depth increases the bending moment of inertia for the panel resulting in less flexible sheets.

Laminate materials forming the panels of food storage pouches provide certain manufacturing advantages because of the uniformly small thickness of the laminates and the resulting flexibility. The flexibility of the laminate material facilitates winding of webs of the material onto rolls for convenient storage prior to pouch construction. The uniform thickness of the laminate provides for compactness of the rolled laminate webs. The flexibility of the laminates further facilitates the handling of the panels that is necessary during pouch construction.

The addition of strand elements to a laminate, as disclosed in Abate, adversely impacts on the above-described desirable characteristics for laminates used for forming food storage pouches. The change in section depth caused by the addition of the strands could limit windability of the laminate web, because of reduced flexibility, and would result in a less compact storage roll for a given length of rolled web. The reduction in flexibility associated with such a modified laminate could also adversely affect pouch handling during manufacture of food storage pouches, possibly requiring that significant modifications be made to the pouch forming machinery.

It is not known to provide a laminate for forming food storage pouches having elongated strips of an expandable polymer material applied to one of the surfaces of the laminate to form relatively rigid reinforcing members following expansion and hardening of the expandable polymer upon activation. Such strips of expandable polymer would remain relatively thin and flexible prior to activation of the expandable polymer material and would, therefore, not adversely affect the desirable characteristics of the laminate prior to pouch formation.

### SUMMARY OF THE INVENTION

The invention provides a pouch for packaging a dry food product. The pouch includes a plurality of panels having opposite sides that are secured together to define a food storage compartment. The pouch further includes at least one elongated reinforcing member secured to at least one of the panels. The reinforcing members include an expandable polymer.

The reinforcing members may include ribs extending substantially perpendicular to the sides of the panels and columns extending substantially parallel to the sides. The reinforcing members may further include footers located adjacent a bottom end of the pouch.

The invention also provides a laminate for forming a reinforced food storage pouch. The laminate includes a plurality of plies each made from a flexible material that are secured together by an adhesive. The laminate further includes at least one elongated strip made from a material comprising an expandable polymer. Each of the strips is applied to a surface of one of the plies to form an expanded and hardened reinforcing member following activation of the expandable polymer.

The invention further provides a method of manufacturing a reinforced pouch for packaging food product. The method includes the step of forming a laminate having plies of flexible material secured together by adhesive applied between the plies. The laminate includes at least one elongated strip of expandable polymer. The method also includes the steps of forming panels from the laminate and securing the panels together. The method further includes the step of activating the expandable polymer of the strips to expand and harden the strips to form relatively rigid reinforcing members.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a perspective view of a stand-up pouch according to the present invention;

FIG. 2 is a sectional view of one of the panels of a stand-up pouch of the present invention at the location of a reinforcing rib shown prior to the curing of the expandable polymer material;

FIG. 3 is a sectional view similar to FIG. 2 shown subsequent to the curing of the expandable polymer material;

FIG. 4 is sectional view taken along the lines 4-4 of FIG. 1; and

FIG. 5 is an elevational view of a stand-up pouch having ribs and column is of an expandable polymer material.

### DETAILED DESCRIPTION OF THE PREFERRED EMBODIMENTS

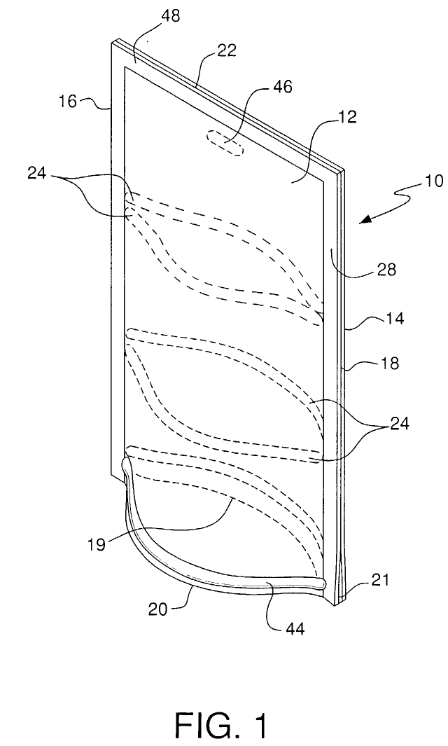

Referring to the drawings, where like numerals identify like elements, there is shown in FIG. 1 a reinforced pouch 10 according to the present invention for protected storage of breakable food items such as cookies, for example. The pouch 10 incorporates a stand-up pouch configuration having front and rear panels 12, 14 secured along opposite sides 16, 18, preferably in a heat sealing process. The present invention, however, is not limited to any particular pouch construction. A pouch according to the present invention could include additional panels, for example, such as a four-sided pouch defining a substantially rectangular storage compartment.

The front and rear panels 12, 14 may be made from any laminate material suited for use in constructing stand-up pouches and preferably includes polymer film plies adhesively joined together. The pouch 10 further includes a bottom panel (not visible) at a bottom end 20 of the pouch 10. The bottom panel includes gusset folds 21, in the known manner, secured between the front and rear panels 12, 14 at opposite sides 16, 18 of the pouch 10. The front and rear panels 12, 14 are also secured together at a top end 22 of pouch 10 to provide a sealed interior storage area.

The pouch 10 includes reinforcing ribs 24 secured to the front and rear panels 12, 14 at spaced locations between the bottom and top ends 20, 22. Each of the ribs 24 extends transversely with respect to the respective one of panels 12, 14 on which it is located between the sides 16, 18. As illustrated by the phantom lines in FIG. 1, and to be described in greater detail below, the ribs 24 are preferably secured to the laminate material of the front and rear panels 12, 14 between plies of the laminate. The addition of the ribs 24 to the laminate material forming the front and rear panels 12, 14 add lateral stiffness to the pouch 10.

The ribs 24 are positioned on the front and rear panels 12, 14 such that each of the ribs 24 of the front panel 12 is vertically aligned with one of the ribs 24 of the rear panel 14. The aligned ribs 24 of the front and rear panels 12, 14 cooperate to limit the adjacent portions of the respective panels 12, 14 from being drawn together. In this manner the ribs 24, although not possessing true hoop continuity, will function to limit lateral collapse of the storage area defined by the pouch 10 thereby protecting the breakable food item stored therein.

The ribs 24 include an expandable polymer. The term “expandable polymer” is understood as identifying a polymeric material that is capable of being applied to a surface of the laminate in a relatively thin and flexible layer that will expand and harden into a relatively rigid bead following activation of the material. Expandable polymers having micro-spheres (also sometimes referred to as “micro-balloons) activated by heat are well known. The heat-expandable micro-spheres are hollow and contain fluid that boils and expands when heated to a temperature below the melting point of the polymeric material. The polymeric micro-spheres can have volumetric expansion ratios as large as 10-20 times as described in U.S. Pat. No. 5,834,526 to Wu for example. The present invention is not limited to expandable polymers activated by heat. Expandable polymers could alternatively be activated by other sources of energy including e-beam, radio frequency radiation, ultraviolet radiation and ultrasonic radiation for example.

The expandable polymer is preferably applied to the front and rear panels 12, 14 of pouch 10 in a liquid form composed of the expandable polymer micro-spheres, a compatible binder such as a thermosetting resin and a compatible solvent. The expandable polymer is preferably applied in a flexographic or retrogravure process. When the liquid expandable polymer composition is cured, by heating for example, the micro-spheres expand and the composition hardens into a low-density mass having very high compressive strength.

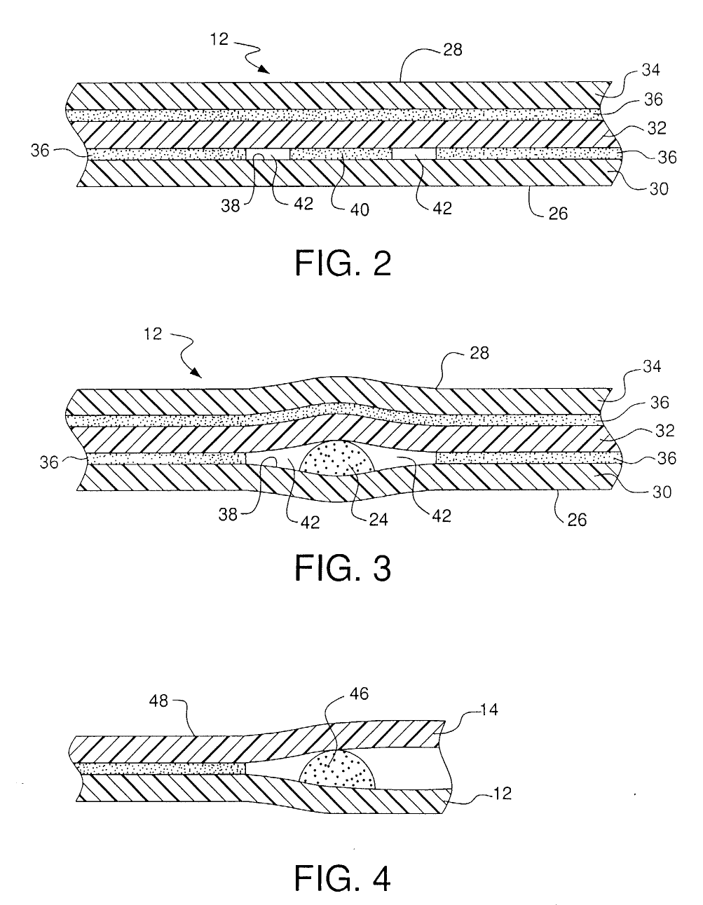

Referring to FIG. 2, there is shown a sectional view of front panel 12 taken at the location of one of the ribs 24 prior to curing of the expandable polymer by heating. It should be understood that the construction of the rear panel 14 is identical to that of the front panel 12. The front panel 12 includes inner and outer surfaces 26, 28. The front panel 12 is made from a laminate of three film plies 30, 32, 34, preferably made from a polymer material. An adhesive 36 is placed between the film plies 30, 32, 34 to secure the plies together to form a laminate. Between film plies 30 and 32, the adhesive 36 is applied to surface 38 of ply 30 in a non-continuous manner as shown. A strip 40 of the expandable polymer composition is applied to surface 38 of ply 30 on a portion of the surface 38 in which the adhesive 36 is discontinuous.

Referring to FIG. 3, there is shown a sectional view of front panel 12 at the same location as FIG. 2. The pouch 10 has been heated to the activation temperature for the expandable polymer such that the strip 40 expands and hardens to form rib 24. To heat the pouch 10 to the activation temperature, the pouch 10 is preferably directed through a heating device such as a heat tunnel, per se known. As shown in FIG. 3, the rib 24 formed by the expanded and hardened strip 40 of expandable polymer has a bead-like shape. To accommodate the expanded and hardened bead-shape of the ribs 24, spaces 42 are provided on opposite sides of the strip 40 of expandable polymer between the strip 40 and the discontinuous portions of adhesive 36 as shown in FIG. 2.

The placement of the strip 40 of expandable polymer between plies 30 and 32 on surface 38 of ply 30, the same surface on which adhesive 36 is applied, facilitates the manufacture of the reinforced pouch process. The present invention, however, is not limited to this arrangement. The strip 40 of expandable polymer forming ribs 24, could, alternatively, be placed on any surface of the laminate, including the surfaces that will form the inner and outer surfaces 26, 28 of pouch 10.

Referring again to FIG. 1, pouch 10 further includes footer ribs 44 extending between sides 16, 18 on the front and rear panels 12, 14 adjacent the bottom end 20 of pouch 10. The footer ribs 44 consist of an expandable polymer composition similar to that forming ribs 24, that has been expanded and hardened to form a bead. The footer ribs 44 are preferably applied to the surface of the laminate forming outer surfaces 28 of front and rear panels 12, 14 as shown.

The pouch 10 further includes a panel separator 46 adjacent the top end 22 of the pouch 10. Referring to FIG. 4, the panel separator 46 consists of a spot of expandable polymer applied to the surface of the web laminate that forms the inner surface 26 of front panel 12. As shown, the presence of the panel separator 46 maintains separation between the inner surfaces 26 of front and rear panels 12, 14. The separation provided by the panel separator 46 facilitates access to the contents of the pouch 10 when the pouch is unsealed such as by tearing or cutting of the pouch 10 adjacent the sealed portion 48 of the pouch 10 at the top end 22.

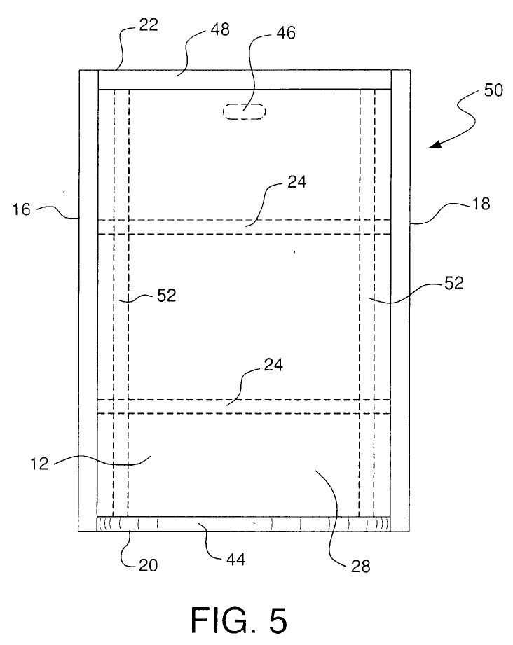

Referring to FIG. 5, there is shown a reinforced pouch 50 according to the present invention. The pouch 50 includes ribs 24 and footer ribs 44 similar in construction and arrangement as the ribs 24 and footer ribs 44 of pouch 10. The reinforced pouch 50 further includes reinforcing columns 52 extending between the bottom and top ends 20, 22 of pouch 50 on the front and rear panels 12, 14. The columns 52 intersect with the ribs 24 to form a reinforcing “skeleton” for the pouch 50.

The columns 52 function to increase vertical stability of the pouch 50 further limiting, in combination with the lateral stability provided by the ribs 24, the collapse of the storage space defined by the pouch 50. The columns 52 preferably consist of an expandable polymer composition, similar to that used to form the ribs 24, applied to the laminate from which the pouch 50 is formed. To facilitate the manufacture of the pouch 50, the columns 52 are preferably applied to the same surface of the laminate on which the ribs 24 are applied.

The expandable polymer strips 40 applied to the laminate web do not need to be activated until after the pouches 10, 50 are fully constructed. Because of the high ratio of expansion of the polymeric micro-spheres, the strips 40 can have a thickness that is relatively small and still form a bead when expanded and hardened that is suitable for the desired reinforcing rib 24. As shown schematically in FIG. 2 by the approximately equal thickness for the strip 40 and the adhesive 36, the thickness of the strip 40 can be small enough such that the overall dimensions of the laminate is not changed. The addition of the strips 40 of expandable polymer, therefore, need not affect the rollability of the web laminate, a desirable feature prior to use of the laminate for forming the pouches 10, 50.

Furthermore, the strips 40 of expandable polymer will not harden into rigid ribs until after the expandable polymer has been activated. Therefore, the flexibility of the laminate web, desirable during the construction of the pouches 10, 50, will not be reduced by the addition of the strips 40 of expandable polymer to the laminate material. Only after the pouches 10, 50 are constructed and subjected to heating to the activation temperature will the strips 40 be expanded and hardened to form the reinforcing ribs 24 thereby stiffening the front and rear panels 12, 14.

Prior to the activation, the flexibility of the laminate material, desirable during the construction of the pouches 10, 50, will be unaffected by the addition of the strips 40 of expandable polymer material. Therefore, no special provisions will need to be made because of the addition of the expandable polymer for handling the laminate material during manufacture of the pouches 10, 50.

The activation temperature of typical heat expandable polymers currently available is approximately 200 to 280° F. The web laminate forming the pouches 10, 50 will, therefore, need to be capable of withstanding environments heated to these temperatures. Because of the relatively high activation temperature, the laminate material from which the pouches 10, 50 are formed, will not be subjected to the activation temperature during storage of the laminate, on rolled webs for example. The shelf life of the laminate material is, therefore, unaffected by the addition of the expandable polymer.

Depending on the respective temperatures for activating the expandable polymer and for heat sealing panels 12, 14, it may desirable to apply the expandable polymer in non-heat seal areas of the pouch so that the expanded polymer will not be activated during the manufacture of the pouch.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the recitation of the appended claims.

What is claimed is:

1. A pouch for packaging a dry food product comprising:
a plurality of panels secured together to define a food storage compartment; and
at least one elongated reinforcing member secured to at least one of the panels, each of the reinforcing members comprising an expandable polymer.

2. The pouch according to claim 1, wherein each of the panels includes a plurality of reinforcing members.

3. The pouch according to claim 2, wherein the panels are made from a laminate having a plurality of plies and wherein at least one of the reinforcing members of each of the panels is positioned between two of the plies of the laminate.

4. The pouch according to claim 2, wherein each of the panels includes opposite sides and wherein the reinforcing members of each of the panels includes at least one rib, each of the ribs extending substantially perpendicular to the opposite sides of the respective panel.

5. The pouch according to claim 4, wherein the reinforcing members of each of the panels further includes a footer, each of the footers extending substantially perpendicular to the sides of the respective panel adjacent a bottom end of the pouch.

6. The pouch according to claim 5, wherein the footers are secured to surfaces of the panels defining an outer surface of the pouch.

7. The pouch according to claim 4, wherein the reinforcing members of each of the panels further includes at least one column extending substantially parallel to the sides of the pouch.

8. The pouch according to claim 1, wherein the panels include opposite sides and wherein the pouch includes a top end and an opposite bottom end, the panels including two opposing panels that are secured together between their sides adjacent the top end of the pouch, the pouch further comprising a panel separator located adjacent the top end, the panel separator secured to a surface of one of the opposing panels and comprising an expandable polymer.

9. The pouch according to claim 1, wherein the expandable polymer is activated by a form of energy selected from the group consisting of heat, e-beam, radio frequency radiation, ultraviolet radiation, ultrasonic and electric current.

10. A laminate for forming a reinforced food storage pouch, the laminate comprising:
a plurality of plies each made from a flexible material;
an adhesive applied between the plies for securing the plies together; and
at least one elongated strip of a material comprising an expandable polymer, each of the strips applied to a surface of one of the plies to form an expanded and hardened reinforcing member following activation of the expandable polymer.

11. The laminate according to claim 10, wherein the adhesive between two of the plies includes discontinuous portions defining at least one space between the adhesive and wherein at least one of the expandable strips is positioned in one of the spaces defined by the discontinuous portions of adhesive.

12. The laminate according to claim 10, wherein at least one of the expandable strips extends substantially perpendicular to at least one other expandable strip.

13. The laminate according to claim 10, wherein the expandable polymer is activated by heat.

14. A method of manufacturing a reinforced pouch for packaging food product, the method comprising the steps of:
forming a laminate having plies of flexible material secured together by adhesive applied between the plies, the laminate including at least one elongated strip of an expandable polymer;
forming a plurality of panels having opposite sides from the laminate;
securing the panels together to define a storage compartment;
activating the expandable polymer of the strips to expand and harden the strips to form relatively rigid reinforcing members.

15. The method according to claim 14, wherein the expandable polymer is heat activated and wherein the step of activating the expandable polymer includes the step of directing the pouch through a heat tunnel.

16. The method according to claim 14, wherein the adhesive between two of the plies includes discontinuous portions defining at least one space and wherein at least one of the strips of expandable polymer is positioned in the space.
